(19) United States
(12) Patent Application Publication
(10) Pub. No.: US 2017/0036416 A1
(43) Pub. Date: Feb. 9, 2017

(54) PROTECTIVE IMPACT ABSORBING STRUCTURES WITH INTERNAL REINFORCEMENT AND MATERIALS THEREFOR

(71) Applicant: G-Form, LLC, Providence, RI (US)

(72) Inventors: Daniel M. WYNER, North Scituate, RI (US); Richard B. FOX, Smithfield, RI (US); Richard L. GARRARD, Reigate (GB); Thomas F. CAFARO, Coventry, RI (US); Maria E. MACRINA, Sherrill, NY (US); Stephanie THORN, Chepachet, RI (US)

(73) Assignee: G-Form, LLC, Providence, RI (US)

(21) Appl. No.: 15/297,101

(22) Filed: Oct. 18, 2016

Related U.S. Application Data
(63) Continuation of application No. 13/847,422, filed on Mar. 19, 2013, now abandoned.
(60) Provisional application No. 61/612,949, filed on Mar. 19, 2012.

(51) Int. Cl. B32B 5/02; B32B 15/02; B32B 5/24; B32B 7/12; B32B 3/26; B32B 5/18

(52) U.S. Cl. CPC B32B 5/022; B32B 3/263; B32B 5/18; B32B 5/24; B32B 5/245; B32B 7/12; B32B 15/02; B32B 5/026; B32B 5/024; B32B 2260/021; B32B 2260/046; B32B 2307/558; B32B 2571/00

(57) ABSTRACT

Disclosed herein are conformable protection pads with a reinforcing layer.

### CROSS REFERENCE TO RELATED CASES

The present application is a continuation under 35 U.S.C. §120 of co-pending and commonly owned U.S. application Ser. No. 13/847,422 filed on Mar. 19, 2013, which claims priority under 35 U.S.C. §119(e) to commonly-owned U.S. Provisional Application No. 61/612,949, filed on Mar. 19, 2012. The subject matter of each of the foregoing applications is incorporated herein by reference in its entirety.

### TECHNICAL FIELD

The present invention relates generally to protective impact absorbing structures designed to protect parts of the human body from injury as well as to protect sensitive items from damage and/or while conforming to the shapes of their respective surfaces and/or providing an exterior surface that is comfortable to touch.

### BACKGROUND

Many activities, especially athletic activities, involve potential risk to the body from impact. Elbows, knees, shoulders, ankles, hips and other joints can be especially susceptible to impact damage and yet are challenging to protect without restricting the range of motion and movement of the individual. Impact protection can be heavy, non-breathable or restrictive, or alternatively does not target certain body parts accurately, or does so inconsistently.

Some impact protection systems consist of separate rigid pads that are heavy, and restrict motion. The rigid components can be lined with some form of soft cushioning to make them comfortable against the body, which is an attempt to cushion impacts to the body, but the extra layers add to the weight and discomfort of the pads. In addition, the padding systems can be hot to wear, and also restrict the evaporation of moisture and sweat.

Other protective pads are made from materials that are softer, so they bend, but offer little in the way of protection against a serious impact, especially an impact from a rock or other hard object. These materials include standard chemically foamed polyether or polyester foams.

Other padding can be made from stiffer foam materials, such as cross-linked polyethylene foams or EVA foams. Such foams offer a bit more protection, but restrict the user's range of motion. Overall, such materials offer insufficient protection, while restricting motion.

There also have been attempts to use stiffer foams as pads, but the foam had to be cut in strips in order to reduce the restriction of movement that a solid foam piece would cause. Unfortunately for the wearer, the strips offered less than optimal protection.

Foam can also be thermoformed into curved or complex shapes, and sewn between layers of material that holds the strips or pieces in place. Other materials that offer better impact absorption such as d30 have also been used in padding, but these materials are also stiff.

Attempts have been made to make the foregoing materials appear less stiff to the wearer by creating thinner regions in each piece which allows better flexing. But protective pads manufactured this way cannot offer full range of motion at the location of the padding, because the material breaks apart when flexed at the thinner areas. These materials also need to be buried beneath layers of fabric because they are not durable or aesthetically pleasing enough to be exposed. The use of covering materials adds unnecessary weight to the padding, and increases the cost of the pads.

A need exists for improved protective padding, particularly for areas requiring range of motion, and for joints.

### SUMMARY

The present disclosure is directed to, in one embodiment, a cushioning material section. The section includes a foam layer disposed between opposing first and second barrier layers, and a reinforcing layer disposed between the second barrier layer and the foam layer.

In some embodiments, the cushioning material includes a porous reinforcing layer. The reinforcing layer can be a nonwoven fabric.

In other embodiments, the cushioning material can be a hydro-entangled nonwoven.

### BRIEF DESCRIPTION OF THE DRAWINGS

Referring now to the Figures, the features and advantages of the present disclosure will be apparent from the following more particular description of exemplary embodiments, as illustrated in the accompanying drawings, in which like reference characters refer to the same parts throughout the different views. The drawings are not necessarily to scale, emphasis instead being placed upon illustrating the principles of the disclosure.

FIG. 1 is a top view of one exemplary cushioning pad according to the present disclosure, with various cushioning regions;

FIG. 2 is a schematic side view of the cushioning pad of FIG. 1, through line 2-2;

FIG. 3 is a schematic side view of the cushioning pad of FIG. 1, through line 3-3;

FIG. 3A shows cross-section views of various exemplary embodiments of moldable cushioning materials that can be used to form the case insert;

FIG. 4 is a top view of another exemplary cushioning pad according to the present disclosure;

FIG. 5 is a schematic side view of the cushioning pad of FIG. 4, through line 5-5;

FIG. 6 is a schematic side view of the cushioning pad of FIG. 4, through line 6-6;

FIG. 7 shows a partial view of a user wearing a compression sleeve in which the cushioning pad of FIG. 4 has been integrated, and showing the conformance of the cushioning pad to the elbow when the elbow is articulated;

FIG. 8 is a front view of a compression t-shirt in which the cushioning pad of FIG. 4 has been integrated;

FIG. 9 is a perspective front view of an exemplary protective case 10 according to the present disclosure, showing a case body and a case insert in an assembled configuration;

FIG. 10 is a back perspective view of the case body shown in FIG. 9;

FIG. 11 is perspective view of the case insert shown in FIG. 9, in an unfolded configuration;

FIG. 12 is cross-sectional view of case 10 shown in FIG. 9, through line 4-4;

FIG. 13 is cross-sectional view of case 10 shown in FIG. 9, through line 5-5;

FIG. 14 is cross-sectional view of the case insert shown in FIG. 11, apart from the case body;

FIG. 15 is perspective view of the case insert being inserted into the case body;

FIG. 16 is perspective view of an alternate exemplary embodiment of a case insert, in an unfolded configuration;

FIG. 17 is cross-sectional view of case body and case insert of FIG. 16, through line 4-4;

FIG. 18 is cross-sectional view of case body with case insert of FIG. 16, through line 5-5; and

FIG. 19 is cross-sectional view of case insert shown in FIG. 9, apart from the case body.

### DETAILED DESCRIPTION

The present invention relates generally to protective impact absorbing and cushioning structures designed to protect parts of the human body from injury as well as to protect sensitive items from damage and/or while conforming to the shapes of their respective surfaces and/or providing an exterior surface that is comfortable to touch.

The present structures include cushioning regions of various shapes, sizes, configurations and thicknesses. For ease of discussion, the terms “cushioning region”, “medallion” and “bumper” will be used interchangeably throughout the description. Various materials can be used for the medallions, as will be described below.

The present structures can be incorporated into clothing, athletic equipment and accessories, and can be designed to have specific functional characteristics. The padding can be incorporated into garments in such a that garment materials fit snugly, but stretch and conform to the body, or to a specific joint shape, resulting in an integrated padding system that protects the wearer from impact better than other products, because the pad is in constant and direct contact with the wearer during the full range of motion. Garments incorporating the present pads provide improved protection from injury when worn, because the base of the pad, or the material to which the base of the pad is attached, can be maintained in direct contact with the user's body during use, when incorporated into clothing that stretches and fits snugly, such as compression clothing. The flexibility of the pads allows the pads to conform to a user's body shape, so that the pad can be maintained in contact with the user's body. That is, without the degree of flexibility of the present pads, the pads would not be capable of conforming to the changing body contours of the user, while in motion. For ease of discussion, the term “flexible,” as used herein, means the ability of the pad to move by bending, twisting, flexing and/or stretching, and the like.

By combining specific shapes, sizes, configurations, contours and orientations of the medallions, hinges, grooves and/or a perimeter flange, with specific pad and clothing materials, garments can be designed to maximize a user's free range of motion, while protecting specific, targeted areas of the body, particularly joints. Such garments are aesthetically pleasing, more durable, lower in cost, more comfortable, and provide significant range of motion and targeted, accurate, protection to the body.

Similarly, the present cushioning pads can be incorporated into other items, such as protective cases. For example, the padding can be incorporated into sleeves or cases that correspond to the shape and size of an electronic device, such as a laptop computer or a media device, such that they fit snugly, but also stretch and conform to the exterior of the case. Cases comprising the present pads can provide lightweight, flexible and impact-resistant protection. The present disclosure describes improved cases that provide improved impact protection, particularly on case edges, lighter weight, improved aesthetics, lower manufacturing costs, and less abrasion to the contained article. The improved cases of the present disclosure comprise separable inner and outer interconnected parts that substantially conform to the outer surface of an article to be protected. The protective case can be adapted for any type of product that requires protection, in addition to those mentioned above. The present disclosure also describes methods of making and materials for the foregoing cases.

The construction of the present pads and items including such pads provide items that are rugged, durable, and able to withstand the temperatures, detergents and mechanical action used in industrial and/or commercial laundering, unlike other padded clothing, which tends to degrade under such harsh conditions. Materials for and methods of making the present structures are disclosed in U.S. patent application Ser. No. 13/208,229, filed on Aug. 11, 2011; and Ser. No. 13/271,594, filed on Oct. 12, 2011, each of which is incorporated herein by reference in its entirety.

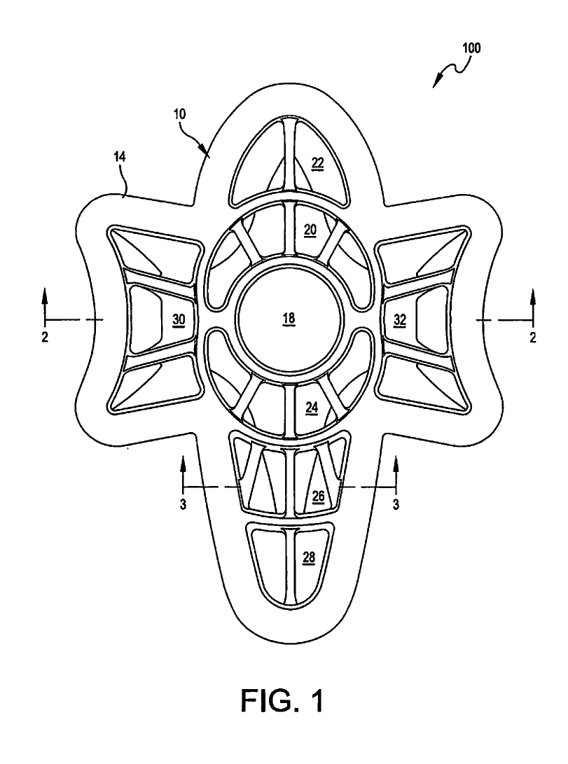

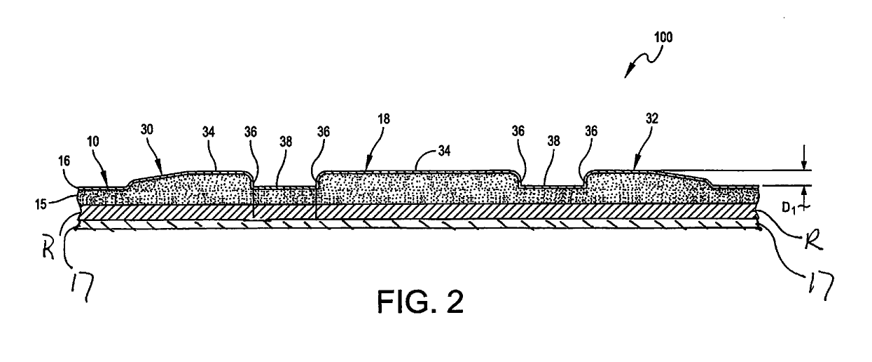

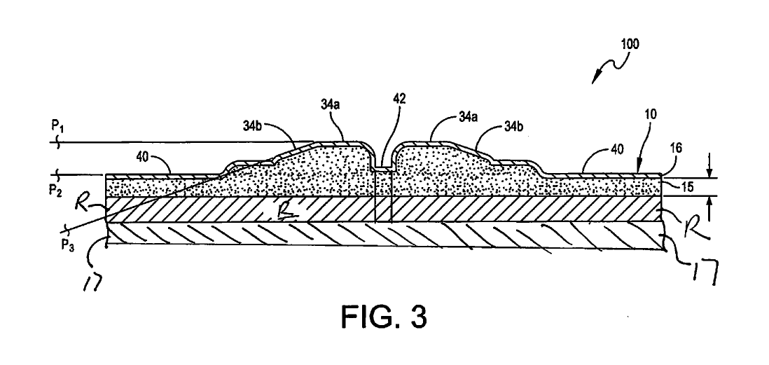

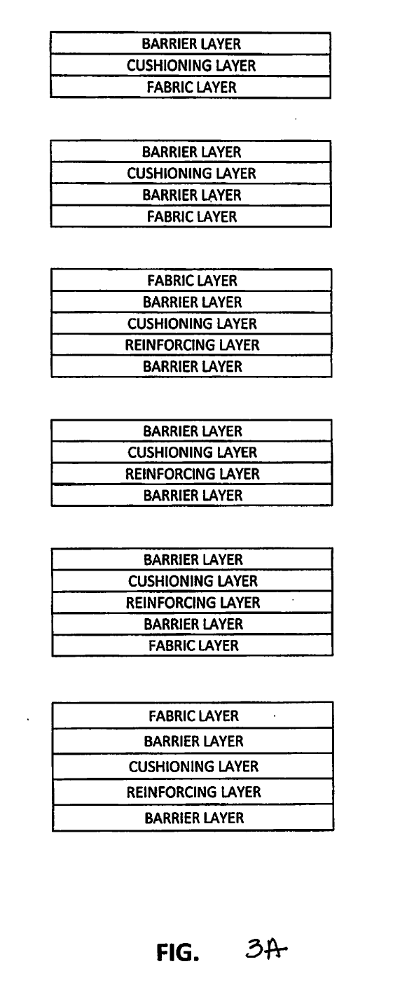

FIGS. 1-3, when taken together, illustrate one exemplary cushioning pad 100 according to the present disclosure. Pad 100 has a shape, size and configuration adapted to the contours of an elbow joint, as noted above, but it should be understood that the pad can comprise any shape, size or configuration as is practical or desired for a particular design or application. As shown, pad 100 comprises a front surface 10, a back surface 12 and a perimeter 14. As shown in cross-section in FIGS. 2 and 3, pad 100 comprises a cushioning layer 15 disposed between optional outer and inner layers 16,17, and a reinforcing layer R disposed between the cushioning layer 15 and the inner layer 17.

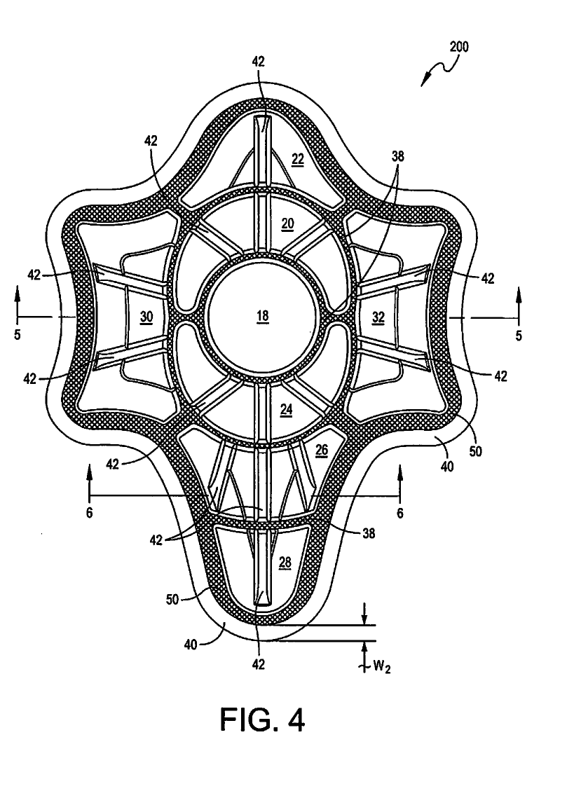

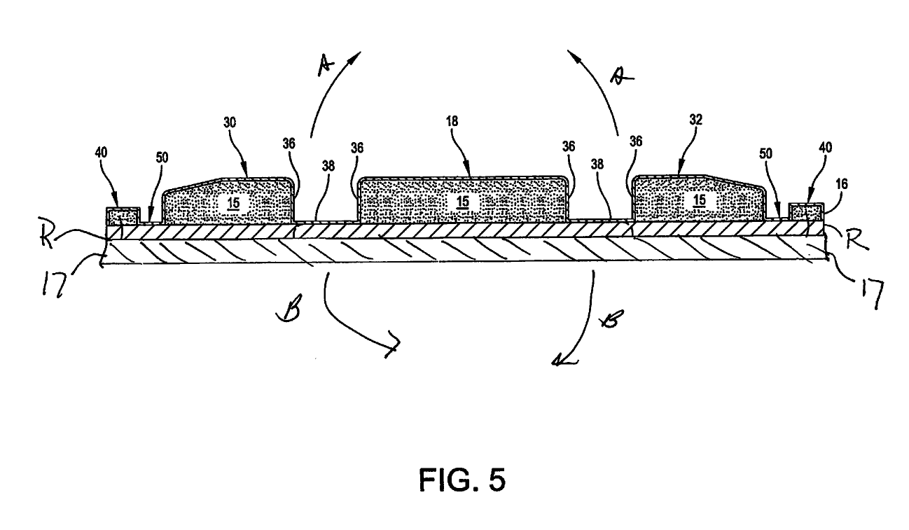

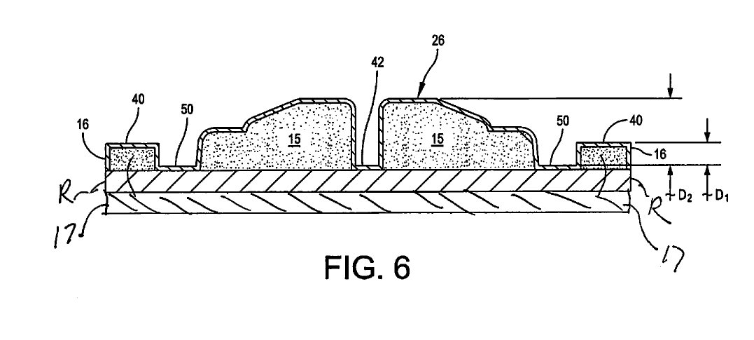

FIGS. 4-6, when taken together, illustrate another embodiment of an exemplary cushioning pad 200 according to the present disclosure. As shown in cross-section in FIGS. 5 and 6, pad 200 has a structure that is similar to pad 100, comprising a front surface 10, a back surface 12 and an outer edge/perimeter 14, with a cushioning layer 15 disposed between optional outer and inner layers 16,17, and a reinforcing layer “R” disposed between the cushioning layer 15 and the inner layer 17.

Pads 100 and 200 comprise a plurality of medallions defined therein, and optionally, one or more grooves 42 may be formed in the upper surface 34 of the medallions. Pads 100, 200 also comprise hinges 38, to maintain the medallions in spaced apart relation, and to provide flexibility to the pad. Pad 200 additionally comprises a perimeter hinge 50, which corresponds to the shape of the perimeter of the pad. Hinges 38, 50 have a width “W₁” defined by the spacing between the perimeter of adjacent medallions; a depth “D₁” defined by the spacing between the upper surface 34 of the medallions the upper surface 10 of the pad 20; and a thickness “T₂” defined by the combined thicknesses of the reinforcing layer R, the inner and outer layers 16,17, and the cushioning material 15, if any, disposed between the layers. The reinforcing material layer R in the foregoing structures provides the structures with improved tear strength and flexibility, particularly in the hinges 38, 58, as well as other advantages described below. As shown, layer R is disposed adjacent to and below layer 15. Alternatively, if desired, layer R can be laminated to the layer 17, provided layer R is porous. Alternatively still, if desired, the foregoing structures can further include an adhesive layer (not illustrated) disposed between layer R and layer 17.

Suitable materials for layers 15, 16 and 17, and the adhesive (if used) are disclosed in the afore-mentioned patent applications, and in U.S. Publication Nos. US 2008/0034614 and US 2009/0255625, each of which is incorporated herein by reference in its entirety.

The relative position of the reinforcing layer R relative to the layers 15, 16, 17 is not limited to the structures described above, and may be varied, as desired. In addition, the type of material used for any or all of layers 15, 16, 17 and R may be varied, as desired. Several exemplary layered arrangements of sections of such materials are disclosed in FIG. 3A. For example, in some embodiments in which it is desirable to use a fabric layer as an outer layer, lower layer 17 may be laminated to the fabric layer, and disposed adjacent to layer 15, with the reinforcing layer disposed between 15,17. In some embodiments, the sections can comprise a polymer material disposed between opposing upper and lower layers of a barrier layer, with one or more reinforcing material layer disposed between the cushioning material layer and the upper and/or lower barrier layers. In any of the foregoing embodiments, the sections may further comprise one or more layers of adhesive disposed between any of the layers, as needed or desired. In addition, any of the foregoing structures may be reversed (not illustrated), such that the relative orientation of the layers is reversed from top to bottom.

Suitable materials for the reinforcing material layer R include, but are not limited to, materials that are sufficiently porous to allow the flow of the cushioning material through the pores or interstices of the reinforcing material during the molding process, such that the cushioning material directly contacts the barrier layer, and bonds thereto. The bonding process may be chemical, mechanical, thermal, and the like, or a combination thereof, and the like.

Suitable porous reinforcing materials R include, but are not limited to, woven and nonwoven fabrics, knits, spacer fabrics, scrim, entangled polyesters (including hydro-entangled and/or air-entangled), and the like. Other suitable materials for the reinforcing layer R include, but are not limited to, knits or wovens, again either laminated or free floating. The knit could be a circular knit, a warp knit, a spacer knit, and the like. The use of a porous reinforcing layer R allows the layer to become saturated with the moldable material and to form a slight surface rigidity of the porous layer, which provides an extra layer of protection during impact, and creates additional structural integrity for the insert.

Suitable nonwoven materials include, but are not limited to, airlaid, spunbond, point bonded, stitch bonded, foams, and the like. One suitable nonwoven material is a hydro-entangled polyester with a weight ranging between about 0.1 and about 15 oz per square yard, more particularly between about 0.5 oz and about 5 oz per square yard, and more particularly still about 1 oz. to about 4 oz. per square yard. If nonwoven, layer R provides improved tear and flex at fold and/or hinge points in the structure with less weight, bulk or expense of a fabric. The foregoing improvements are increased even without the optional fabric and/or lining. The use of the nonwoven for the R also provide a sleek, waterproof and cleanable exterior, while still providing rip resistance in the seams. An advantage of random nonwoven fibers, as opposed to knits or wovens, is improved softness, and a reduced or eliminated tendency knuckle when flexed or bent. The random nature of the nonwoven structure may provide improved softness and in some instances improved tear strength at the fold lines and/or hinges.

The use of Kevlar, metal woven or knit fabrics for the reinforcing layer R provides piercing and/or or stabbing protection from sharp objects; the use of wire mesh or a bendable porous substrate provides the ability to shape the insert; the use of a spacer fabric improves the tear strength, and provides an additional deflective impact layer; the use of an aerogel nonwoven provides superinsulation; the use of a phase change fabric such as Outlast provides energy storing properties; the use of a static dissipating fabric or nonwoven provides static discharge; the use of active agents, such as silver, provides properties such as antimicrobial activity; the use of selectively die cut fabric or scrim provides areas of selective stretch or strength depending on the size, shape and position of the selected portions of the reinforcing layer; the use of a silicone or other plastic mesh provides heat resistant and/or strength.

The use of active agents in one or more of the inner layer, outer layer, reinforcing layer and/or the cushioning layer can be desirable. For example, the addition of a silver or copper based active agent can provide the material with antimicrobial or antifungal properties. The use of actives in the inner or outer layer or the foam itself can be desirable, such as the addition of silver or copper based actives to act as an antimicrobial or antifungal agent.

In the present embodiment, the thickness of the cushioning layer 15 in hinges 38,50 is minimized during the manufacturing process, such that its thickness approaches zero in the hinges 38,50. As a result, the cushioning material in the hinges 38,50 may not be visible to the naked eye, or only detectable using very sensitive thickness gauges.

The residual cushioning material remaining in between the layers may assist in bonding the layers together in the hinges 38,50. Depending on the materials used, the bonding between layers may be at least partially a chemical, thermal and/or mechanical bond. For example, if the material used as the cushioning layer is a resin, the residual resin in the hinges 38,50 can function as an adhesive to bond the layers together. Use of the resin as a bonding agent is advantageous, because it eliminates the need for a separate adhesive in the very thin hinge areas, and it keeps the bond consistent and equally flexible throughout pad, thereby enhancing the durability of the pad.

Alternatively, if a fabric is used as one of layers 16,17, the bond between the layers in the hinges may be at least partially mechanical, as a result of the resin being squeezed into opening or pores in the fabric, such that portions of layers R and 16,17 bond during manufacturing, resulting in “islands” of bonded layers 15,16,17 disposed between islands of bonded layers 16,17.

By minimizing or eliminating the cushioning layer 15 in hinges 38,50, the flexibility of the hinges is maximized, such that the entire pad 200 is capable of bending, flexing, folding and twisting in a variety of direction. For example, pad 200 is capable of bending or flexing along the hinges 38,50 by as much as 180 degrees in the direction of arrow “A,” as shown in FIG. 5. In the opposite direction “B,” the flexibility is limited only by the thickness and spacing of the medallions.

In the present embodiment, the presence of the continuous bond between the inner and outer layers 16,17 in the hinges 38,50 is advantageous because it “locks” the medallions in place, minimizing or preventing the egress of cushioning material from the pad or, alternatively, minimizing or preventing the ingress of materials, such as fluids, into the pads. Therefore, the hinges 38,50 stabilize the pads, particularly the cushioning material, such that fluids and other materials are not able to penetrate the pad, which might otherwise lead to delamination. In addition, the presence of the reinforcing layer R in the thin hinge areas increases the tear strength in the hinge areas.

When the pads are molded with a front layer, a back layer, or both layers, the maximum pad flexibility may be achieved when the hinge thickness approximately corresponds to the combined thickness of the layer(s) other than layer 15, or when the thickness of the cushioning layer 15 approaches zero.

For example, in the embodiments described above, both the outer and inner layers 16,17 are continuously bonded to cushioning layer 15 across the entire pads, including in the hinges. Depending on the construction of the pad, the outer and inner layers may be bonded to cushioning layer 15, or they may be bonded to each other, when the amount of material in the hinges is minimized or eliminated. One significant advantage of bonding the front layer to cushioning layer 15 is to provide a continuous, uninterrupted surface above and below cushioning layer 15 i.e., to encapsulate cushioning layer 15, other than at the perimeter of the pad. The continuous upper and lower layers strengthen the hinge and groove areas, minimizing breakage in the hinges and/or grooves, which may otherwise occur due to the flexing of the pad during use, because the hinges and/or grooves are thinner than the medallions. At least one bonded layer may be used for the protection of the thin hinge areas during flexing. A thermoplastic polyurethane film, when used as the outer layer 16, is particularly good at preventing cracking or breaking of layer 17 in the hinges or grooves. The inner layer can also provide strength to the hinges or grooves if bonded to the foam, or in many embodiments, both inner and outer layers are bonded to the foam. In cases where the hinge thickness is very low, especially with little or no film in the hinge, both inner and outer bonded layers are desirable to maintain the structural integrity of the pads, with or without the reinforcing layer R. It is desirable to use a material with substantial elasticity for the inner and outer layers, such as TPE films, spandex fabrics, and the like. In some embodiments, the use of a fabric with a laminated film backing may be desirable as an inside or outside layer. An inner layer that is a laminate of a fabric and a film, such as a polyurethane film laminate, can be very desirable for maximizing the durability of the hinges.

As described above, another aspect of the present disclosure is the integration of the above-described pad into garments, particularly compression garments, to protect specific areas of the body. When one of the foregoing pads is integrated into a compression sleeve or garment that is tightly fitting to the wearer, the hinged and/or grooved multilayer pad structure is sewn, adhered or otherwise attached to a spandex fabric or otherwise stretchable material in such a way that the hinged pads are held in form fitting contact with the area to be protected. The pad can be sewn to the inside or outside of a garment. It may be desirable to have the pad cover only a portion of the full circumference of the sleeve, so that the sleeve can still stretch significantly to fit the wearer. The integration of the uniquely hinged protective pad with the compression garment offers particular synergies by creating a simple way to add a significant impact absorbing pad to specific body areas, without altering the entire garment.

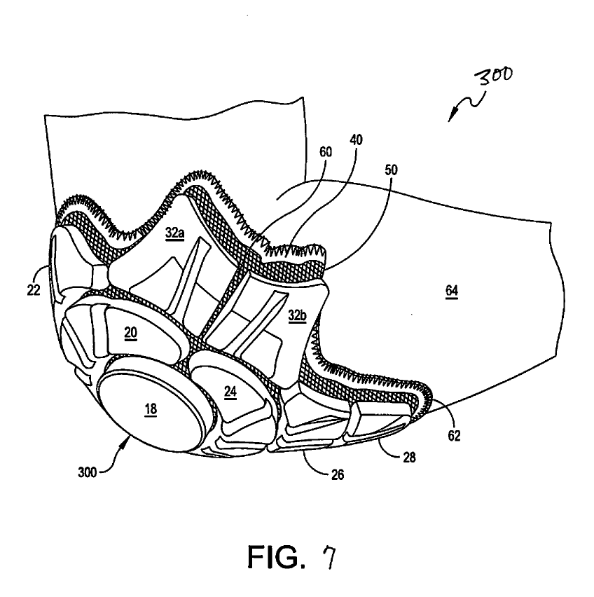

FIG. 7 shows a compression sleeve 300 comprising a cushioning pad, attached to the body 64 of the sleeve. As shown, the pad is attached to the sleeve 300 by stitching the perimeter flange 40 to the body 64 of the sleeve 500, such that in use, the position of the center medallion 18 corresponds to the user's elbow. In use, when the user's arm is bent, the combination of the flexible hinges 38 and grooves 42 allow the pad to conform to the bent configuration of the user's arm, while maintaining the position of center medallion 18 relative to the elbow.

When the pad is integrated with a compression sleeve, some unique properties and advantages are provided in comparison to other methods of protecting moving joints. When integrated into a compression sleeve, the pad can be in continuous intimate contact with the joint to be protected, which may be desirable when protecting flexible joints such as knees, elbows, shoulders and ankles, because properly designed hinges allow the protective sleeves to naturally remain in the correct position and orientation. When hinges are properly designed, the protective compression sleeve moves as one with the arm, allowing much wider range of motion than traditional padding.

Also, with the protective sleeve in intimate contact with the joint and skin, there is no additional impact caused by the pad hitting the skin or joint after impact from an outside object. Stiffer pads may not be capable of being in continuous contact with the specific body area or joint, because they are not flexible or form-fitting. If not form-fitted, the pads may become part of the impact that injures the wearer. Pads in a sleeve configuration are uniquely better able to protect a moving joint, because they can wrap around a wide radius, and in some instances provide 360 degrees of protection by wrapping the entire joint. In general, it is desirable to leave some area of the compression sleeve without the additional padding layers, to allow the sleeve to stretch and conform better to the arm.

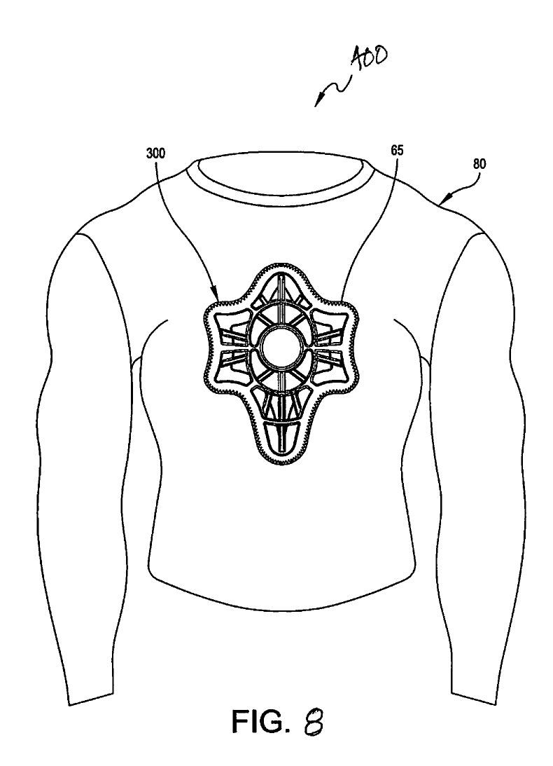

FIG. 8 shows a compression shirt 400 comprising a cushioning pad, attached to the body 80 of the shirt. As shown, the pad is attached to the shirt 400 by stitching the perimeter flange 40 to the body 80 of the shirt, such that the position of the center medallion 18 corresponds to the center of the user's chest. In use, the combination of the flexible hinges 38 and grooves 42 allow the pad to conform to the user's chest region, maintaining the pad in close proximity to the user body, thereby maximizing the impact-absorption capability of the pad when the user is subject to an impact in the chest region. The garments can also be made from a wicking fabric that is designed to move moisture away from the skin layer.

The present pads also may be designed to enhance air and/or moisture transmission, without significantly compromising protection, which is not an option with other protective padding. The hinges, grooves and/or medallions may comprise perforations (not illustrated), which enhances moisture or air transmission rates. The use of a wicking fabric as the inner layer or in combination with a TPE film layer as the inner layer, can enhance comfort as well and wick moisture through the hinges. Also, the use of a high moisture vapor transmissive (“MVT”) film layer can further enhance comfort. Such films can function by chemical absorption/desorption. Examples of such films are available under the product name Sympatex, or TX1540 from Omniflex. The use of microporous high MVT films such as Goretex or Porelle (by Porvair) can also be used, or other similar films.

The present pads/structures may be manufactured using techniques disclosed in the foregoing '614 Publication. The molds for the present pads are designed to allow layers 15,16,17,R to be compressed together under conditions sufficient to minimize or eliminate the foam in the hinges 38,50, for certain embodiments of the pads, while allowing the layers to bond together, which may be a chemical, thermal and/or mechanical bond.

The use of bonded hinges that approach zero thickness for cushioning layer 15 is very unique. In such near zero thickness hinge areas, the top surface of the outer layer is still bonded to the inner layer throughout the hinge that can allow dramatically improved range of motion in specific, selected areas. As noted, hinge areas can be anywhere from near zero thickness (less than 0.001″ (1 mil) of foam) or much higher, provided that they are less than the thicker areas of cushioning material. Some embodiments have hinge areas near zero while others are at 0.010″ (10 mils), 0.020″ (20 mils) or even 0.080″ (80 mils) or 0.120″ (120 mils). The combination of both hinge and groove areas in multiple orientations allows the formation of pads that combine the full range of motion where needed, but protective padding in other areas where less flex is required.

Where near the thickness of the hinge areas approaches zero, or in thin hinge areas (less than 0.100″ (1 mil) foam), the fact that the entire pad has a continuously bonded inner or outer layer (or both) maintains spacing and prevents separation of an unprotected area. This is in contrast to pads in which separate cut pieces are used to create the pad, because the cut pieces can separate under duress and allow the user to be exposed, and possibly injured.

The present pads can be manufactured to provide better protection to specific body areas while being lightweight, which is a significant advantage to athletes and active individuals.

Similarly, the “network” of hinges throughout the cushioning pads, particularly when the hinges are “near zero” hinges, further improves the durability of the pads, because eliminating and/or minimizing the foam, or other cushioning material in the hinge area, increases the bond strength in the hinges. When the reinforcing layer is included, the tear strength is increased. The bond strength is increased in the hinge area because the remaining cushioning material in the hinge areas is insufficient to support the foam structure (in the case of a foam). If foam remains in the hinges, the bond strength may be limited to the foam tear strength. Thus, when the thickness of the foam, or other cushioning material, is minimized, the bond in the hinges increases, because there are no thin foam cell walls to tear. That is, without a cellular foam structure in the hinges, there is no space for fluid and/or particulate penetration beyond the perimeter flange. As a result, if a single medallion or hinge is damaged or compromised, damage to the entire pad is minimized or compartmentalized, because the damage may extend only to the adjacent pad and/or hinge.

Another aspect of the present disclosure is an improved case that provides improved impact protection, particularly on case edges, lighter weight, improved aesthetics, lower manufacturing costs, and less abrasion to the encased article. The improved cases of the present disclosure comprise separable inner and outer interconnected parts that substantially conform to the outer surface of an article to be protected. The protective case can be adapted for any type of product that requires protection, in addition to those mentioned above.

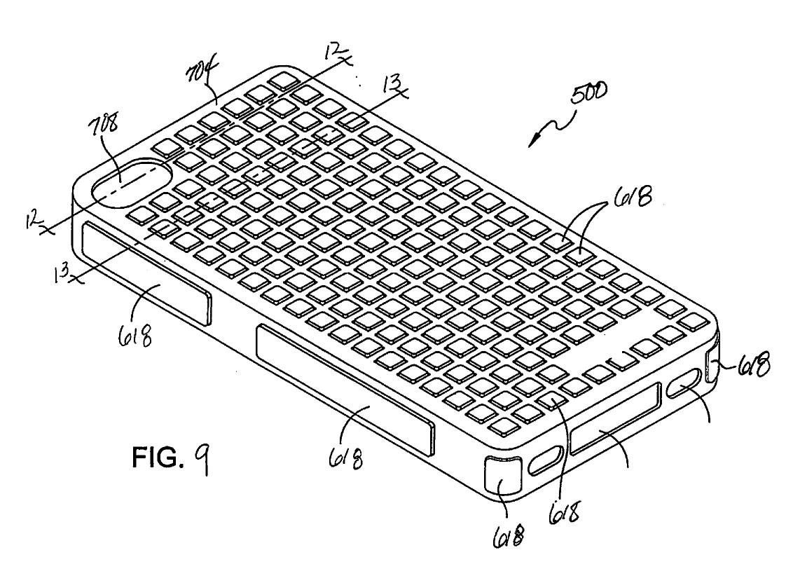

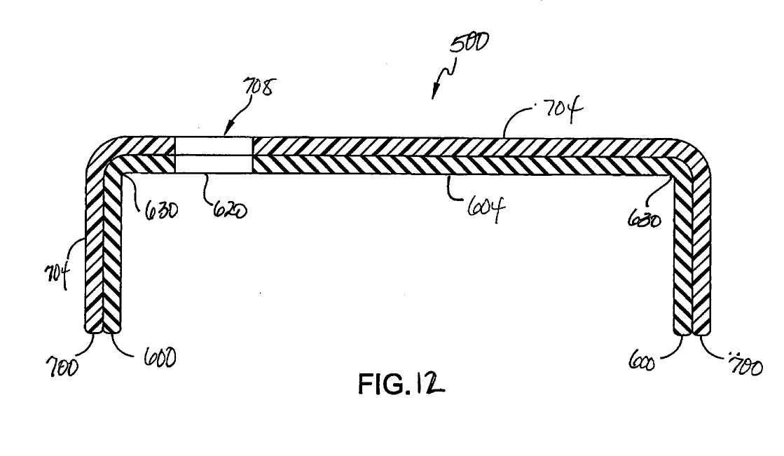

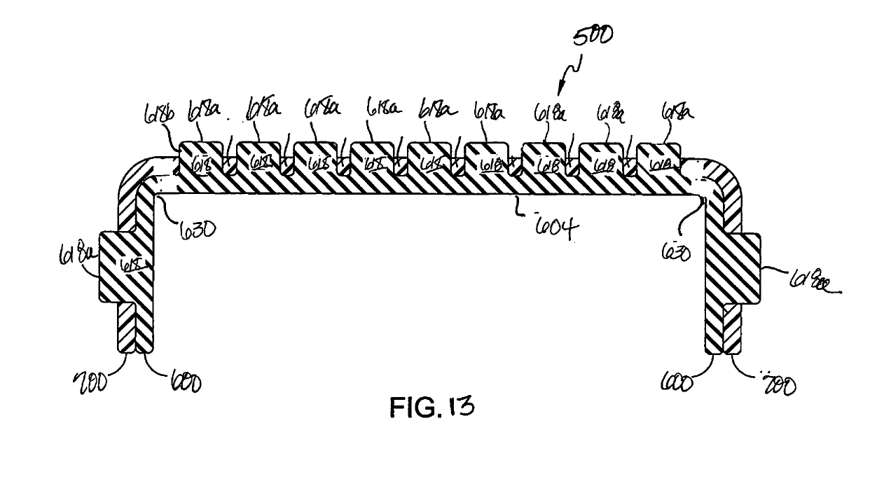

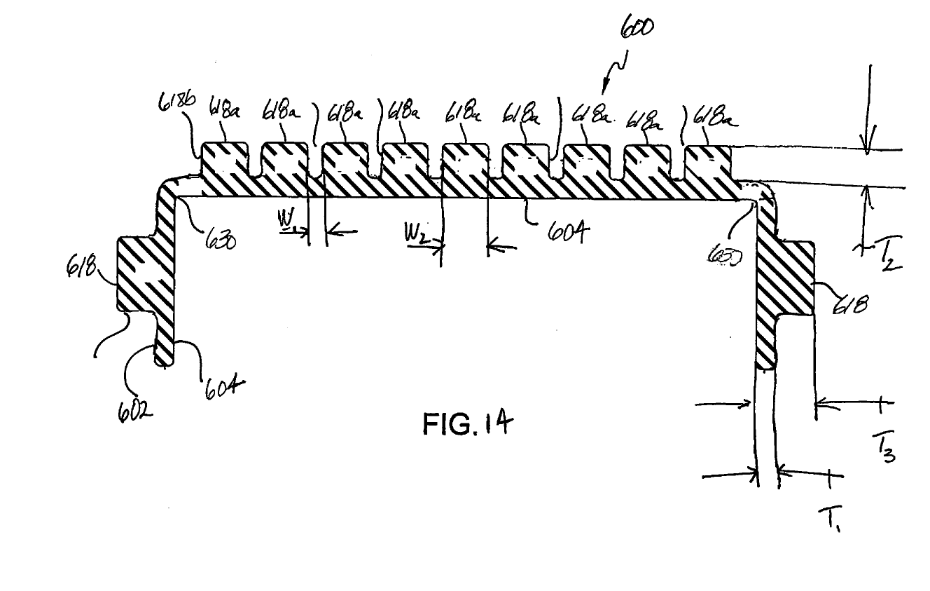

FIGS. 9-15, when taken together, illustrate one exemplary embodiment of the present disclosure, which is directed to a protective case for a cell phone. Although described herein with reference to a cell phone, those of ordinary skill in the art would recognize that the present cases may be used in variety of applications, for any type of product that requires protection. For example, the concepts described herein also apply to larger cases for devices such as the iPad, any luggage with a hard shell, athletic protective gear, and the like. As such, the case bodies and inserts can be formed in shapes that would conform at least in part to the outer surface of the encased product.

As shown in FIG. 9, case 500 comprises a case insert 600 and a case body 700. The case insert 600 may be constructed to conform to at least a portion of the outer surface of the article it is intended to encase which, in this example, is a cell phone, and the case body 700 may be constructed to conform to the exterior surface of at least a portion of the case insert 600.

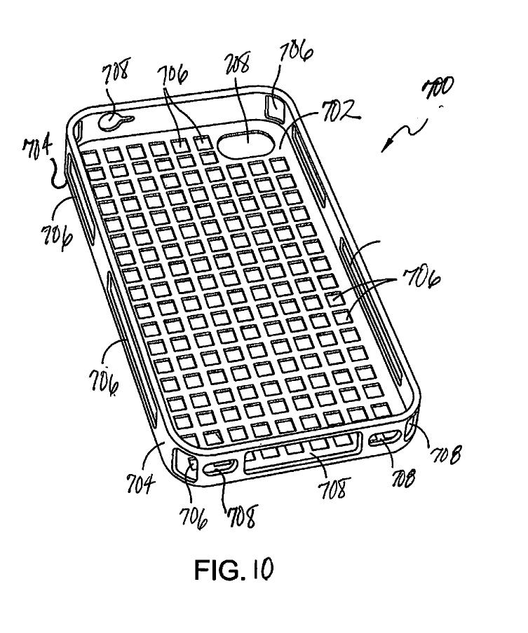

The case body 700 is shown in greater detail in FIG. 10. As shown, case body 700 comprises an interior surface 702 and an exterior surface 704, and a plurality of apertures 706 extending therethrough. The case body 700 also comprises one or more apertures or holes 708 that correspond in shape, size and location to the size, shape and location of function keys or other items, to keep such items free of obstruction (such as the charging port, the antenna, the camera view finder, and the like).

The case body 700 may be formed of a substantially rigid, semi-rigid and/or flexible material. When rigid, the case body 700 may be formed from a hard plastic material, of the type that is typically used for cell phone covers. The case body 700 has a size and configuration corresponding to the case insert, with sufficient space between the inner surface of the case body and the outer surface of the cell phone, to allow the case insert to be disposed therein.

As shown, the case body 700 is shown as a single, unitary part, but if desired, the case body may be formed as two or more parts with interlocking edges that are assembled onto the front and rear surfaces of the cell phone. Similarly, the case insert 600 may be formed as two separate parts that correspond to each case body part, and that can be inserted into each of the case body parts prior to assembly.

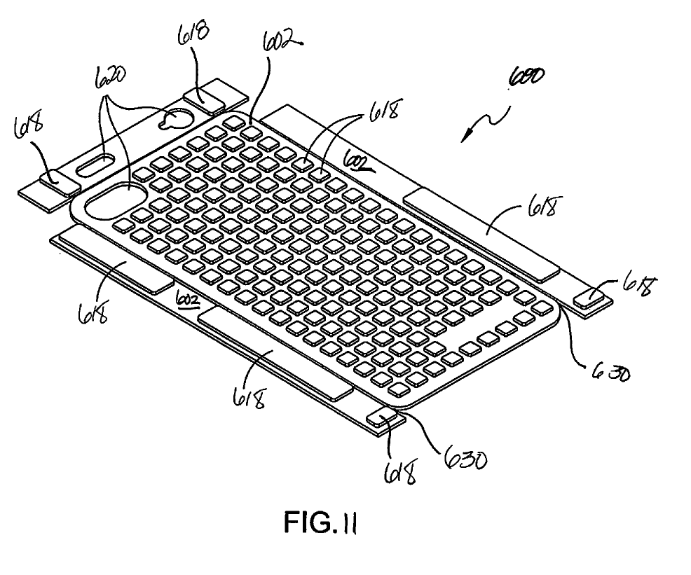

FIG. 11 illustrates the case insert 600 in greater detail. The case insert 600 may be constructed to conform to at least a portion of the outer surface of the article it is intended to encase which, in this example, is a cell phone. In the present exemplary embodiment, case insert 600 comprises spaced apart inner and outer surfaces 602,604, and a plurality of medallions (hereinafter “bumpers 618”) defined in and extending upwardly from the outer surface 604, which correspond to the apertures 706 disposed in case body 700 (as described above). Bumpers 618 are spaced apart from one another by channels, as described above, and have a thickness T₁ a width W₁, which may vary as desired. Bumpers 618 have a thickness T₃, greater than the thickness T₁ of the channels, and protrude above the outer surface of the insert by thickness T₂.

All of the foregoing thicknesses, widths and spacings may vary, as desired.

Bumpers 618 comprise an upper surface 618a and sidewalls 618b extending downwardly therefrom. The bumpers 618 may have any thickness sufficient to provide a protective or comfortable effect, by protruding above the exterior surface of the case body 700. Thus, for certain functional advantages, the thickness of the bumpers 618 may be designed to protrude above the outer surface of the case, when in an assembled configuration. For example, in the present exemplary cell phone device case, the bumpers 618 may protrude above the outer surface of the case insert 600 by about 1/16 inch to about ½ inch. If desired or needed, the case insert 600 also can comprise bumpers designed to protrude adjacent to the screen side (e.g., a bezel) to protect the screen during a fall.

The thickness of case insert 600 may be varied as desired, but it is desirable for the thickness to be sufficient to protect the device from impact, while remaining thin enough to minimize the total weight of the case.

If desired, the case insert 600 can be formed such that a portion of foam protrudes onto the glass screen edge to act as a soft bezel to protect the screen side (not illustrated).

Although illustrated herein as substantially square, the bumpers 618 may have any shape or configuration as is desired to achieve the functional advantage of impact protection, or the aesthetic design intended to appeal to a consumer. The size, shape, quantity, configuration and location of the bumpers may be varied as desired in order to achieve the foregoing objectives. For aesthetic purposes, the color of the case bodies and inserts may be the same or different, and they are also amenable to the use of graphics.

The case insert 600 also comprises one or more apertures or holes 620 that correspond to those in the case body 700, which correspond in shape, size and location to the size, shape and location of function keys or other items that must remain free of obstruction (such as the charging port, the antenna, the camera view finder, and the like).

If desired, the case insert 600 can be formed such that a portion of foam protrudes onto the glass screen edge to act as a soft bezel to protect the screen side (not illustrated).

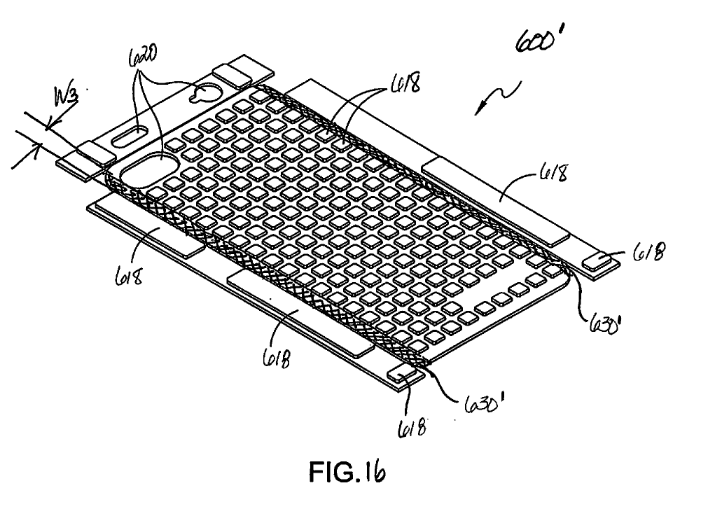

The case insert 600 is shown in FIG. 11 in a planar or unfolded configuration, prior to being inserted into the case body 700. To facilitate insertion of the case insert 600 into the case body 700, the case insert 600 also may comprise fold lines 630 and/or fold regions 630′ (best seen in FIG. 16) that correspond to the contours, edges and/or corners of the cell phone. If desired, the fold lines 10 and/or fold regions 30′ may have a thickness T₄ less than the thickness T₁ of the spacer regions S.

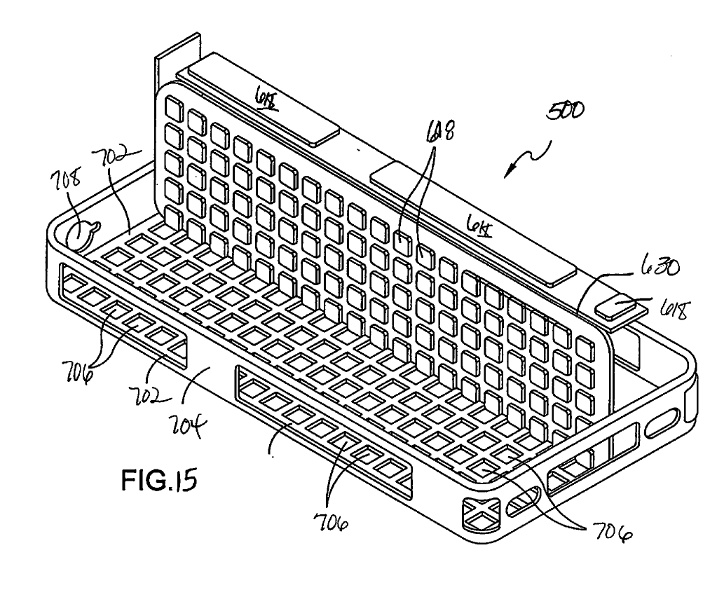

FIG. 15 shows the case insert 600 being inserted into the case body 700. As mentioned above, when in a planar configuration, the case insert may include fold lines 630. Therefore, to assemble, the case insert is folded along the fold lines 630 and/or fold regions 630′ and inserted into the case in such a manner that the corresponding bumpers and apertures are lined up, and the bumpers are inserted into the corresponding apertures until they extend through the upper surface of the case.

When assembled, the bumpers protrude from the corresponding apertures on the case body, and the spacer regions S between the bumpers are disposed underneath the case body, between the bumpers. The protruding bumpers function at least to protect the case body from impact, and the spacer regions disposed underneath the case body also absorb energy through the material disposed between the device and the case body. Thus, the case 10 provides impact resistance and energy absorption, as a result of the external exposed bumpers and the internal case insert beneath the case body, which is a unique feature. Although illustrated herein with apertures 706 adapted to receive bumpers 618 therein, the case body can be formed to comprise recessed regions, rather than apertures, to receive the bumpers 618 therein (not illustrated).

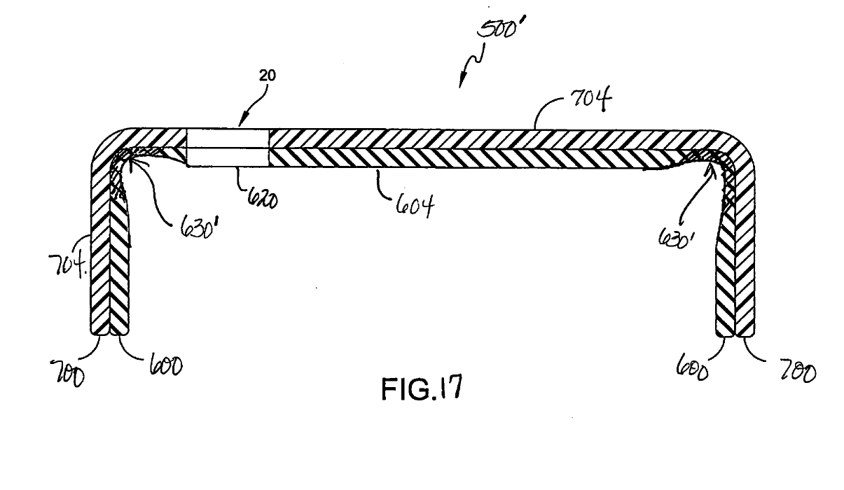

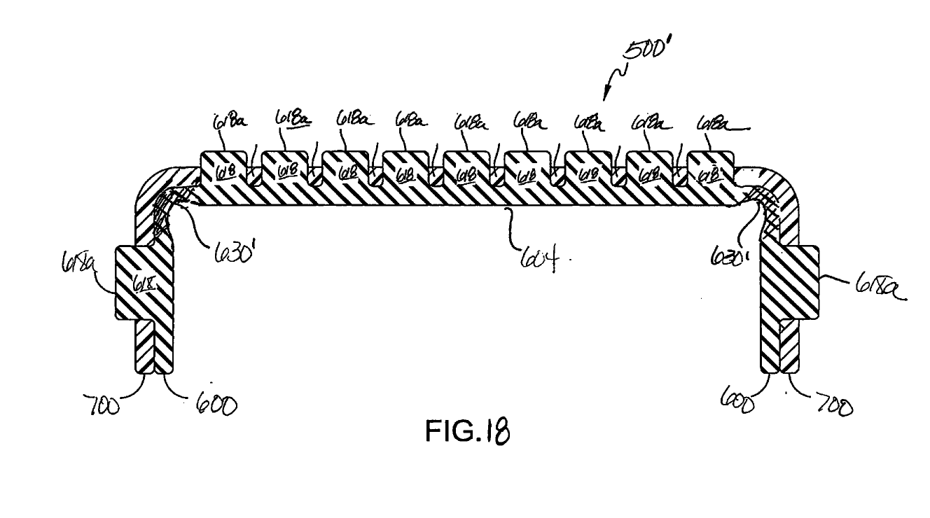

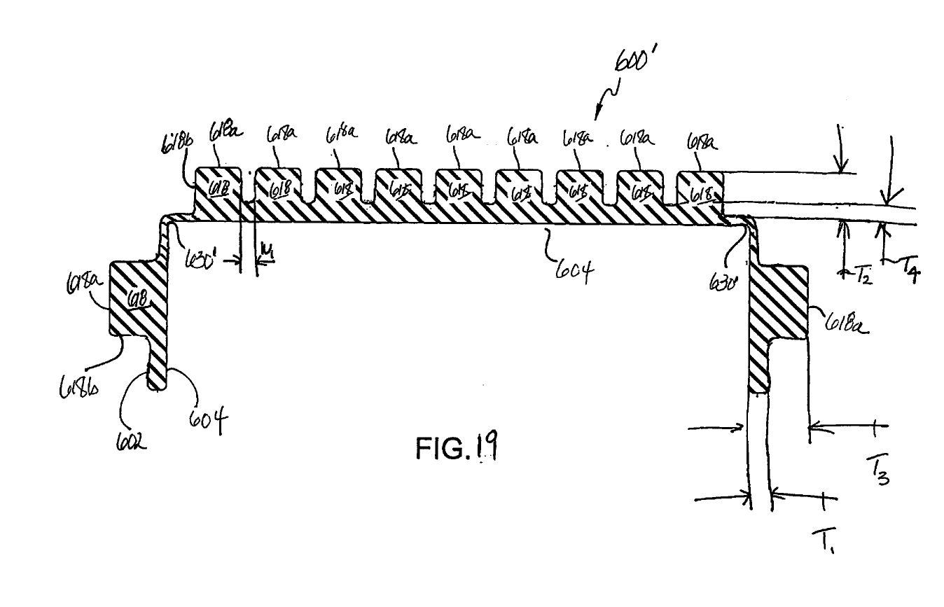

Another embodiment of a case 500′ is shown with reference to FIGS. 16-19, which comprises the same case body 700 as in the previous embodiment. The case insert 600′ has a construction similar to the case insert 600, and additionally includes fold regions 630′, rather than fold lines 630.

As noted above, the color and/or pattern of both the case body and case insert may be varied for aesthetic reasons. The case may be sold as a kit comprising a two or more case bodies and/or two or more case inserts with different colors, patterns and/or graphics, to allow a consumer to swap the case bodies and case inserts, as desired.

As shown, section 100 comprises a polymer material disposed between an upper barrier layer and a lower fabric layer. Alternatively, section 200 may comprise a polymer material disposed between upper and lower barrier layers, with the lower barrier layer being laminated to a fabric layer. Alternatively still, section 300 may comprise two layers of fabric material, one disposed adjacent to each of the upper and lower barrier layers, and reinforcing layers may be disposed adjacent to each of the barrier layers.

Many materials, including foam materials, may degrade over time due to wear and abrasion, thereby generating particles that may penetrate into the device and cause functional problems. Having raw foam cells exposed is not desirable as the foam cells can entrap dirt or dust and be unaesthetic and also scratch the device. Therefore, it also may be desirable for the molded foam to have a suitable top surface bonded to it to offer the appropriate aesthetics and or surface characteristics if it is used as an outside exposed layer. This could be a film, film laminate or textile or leather or combination of these.

Encapsulating the case insert 600 foam by including a protective or barrier layer on one or both of the opposing surfaces of the case insert 600 can prevent or minimize wear, abrasion, particulate formation, and can provide moisture protection to the foam. Thus, the case insert can comprise multiple layers, such as a soft foam part with a continuously bonded top surface layer, wherein the top surface of the soft part protrudes through openings in the hard case. In such cases the flat side or bottom layer textile or film can be selected so as to make an lining for the case. The continuous bonded film or fabric layer running across the entire insert provides substantially improved durability in comparison to the foam without the continuous layers.

When the continuous bonded film is used, the thickness of the case insert disposed between the bumpers may range from 0.020″ (twenty thousandths of an inch), but it could be thicker or thinner or could be zero (if the overall shock protection is not needed). A thickness of about 0.020″ to about 0.060″ is desirable for shock absorbance, without adding too much thickness. The ability to vary the overall (between aperture foam) and the outside extension and size of bumps is important to protect both the case from impact and the device from shock. These thicknesses can be customized as needed for other devices, such as a camera cases, lens cases, luggage, ipads, etc.

One disadvantage of a hard plastic cases used as protective cases for electronic devices is that when a device is dropped, the case cracks frequently and must be replaced. The present protective case has an additional advantage that it protects the hard case from breaking because the protruding bumpers first break the impact.

Another disadvantage of many protective cases is that the device inside is more susceptible to breakage from side or edge impacts than from a front or back impacts. In the present cases, the use of impact-absorbing foam for the insert, such as PORON XRD, provides protection from such an impact.

It should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Similarly, it is noted that the terms “bottom” and “top” are used herein, unless otherwise noted, merely for convenience of description, and are not limited to any one position or spatial orientation. In addition, the modifier “about” used in connection with a quantity is inclusive of the stated value and has the meaning dictated by the context (e.g., includes the degree of error associated with measurement of the particular quantity).

Compounds are described using standard nomenclature. For example, any position not substituted by an indicated group is understood to have its valency filled by a bond as indicated, or a hydrogen atom A dash (“—”) that is not between two letters or symbols is used to indicate a point of attachment for a substituent. For example, —CHO is attached through carbon of the carbonyl group. Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). The notation “+/−10% means that the indicated measurement may be from an amount that is minus 10% to an amount that is plus 10% of the stated value.

Finally, unless defined otherwise, technical and scientific terms used herein have the same meaning as is commonly understood by one of skill in the art to which this disclosure belongs.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof Therefore, it is intended that the disclosure not be limited to the particular embodiment disclosed as the best mode contemplated for carrying out this disclosure, but that the disclosure will include all embodiments falling within the scope of any appended claims.

What is claimed is:

1. A cushioning material section for a stretchable, conformable impact absorbing pad structure, comprising a foam layer disposed between opposing first and second barrier layers, which first and second barrier layers are stretchable and conformable and a reinforcing layer disposed between the second barrier layer and the foam layer.

2. The cushioning material section of claim 1, wherein the reinforcing layer is porous.

3. The cushioning material section of claim 2, which is sufficiently porous to allow flow through its pores or interstices of a foam layer precursor during formation.

4. The cushioning material section of claim 3, wherein the reinforcing layer is flexible.

5. The cushioning material section of claim 4, wherein the reinforcing layer is a non-woven fabric.

6. The cushioning material section of claim 5, wherein the reinforcing layer is a hydro-entangled nonwoven.

7. The cushioning material section of claim 5, wherein the first and second barrier layers are first and second thermoplastic elastomer (TPE) layers.

8. The cushioning material section of claim 7, further comprising a first fabric layer disposed adjacent to the first TPE layer, opposite the foam layer,

9. The cushioning material section of claim 7, further comprising a second fabric layer disposed adjacent to the second TPE layer, opposite the reinforcing layer.

10. The cushioning material section of claim 8, further comprising a second fabric layer disposed adjacent to the second TPE layer, opposite the reinforcing layer.

11. The cushioning material section of claim 7, further comprising a first fabric layer disposed adjacent to the first TPE layer, opposite the foam layer, and a second fabric layer disposed adjacent to the second TPE layer, opposite the reinforcing layer.

12. The cushioning material section of claim 1, comprising one or more cushioning regions which comprise a foam layer disposed between opposing first and second barrier layers, which first and second barrier layers are stretchable and conformable and a reinforcing layer disposed between the second barrier layer and the foam layer, the one or more cushioning regions having a first thickness and which further comprises one or more hinge regions which comprise opposing first and second barrier layers, which first and second barrier layers are stretchable and conformable, and a reinforcing layer disposed between the first and second barrier layers with a foam layer disposed between the first barrier layer and the reinforcing layer, the one or more hinge regions having a second thickness being less than the first thickness.

13. The cushioning material section of claim 1, further comprising a stretchable and conformable impact absorbing pad structure.

14. The cushioning material section of claim 12, which is integrated into a garment of stretchable and conformable material.

15. The cushioning material section of claim 12, which is integrated into a sleeve or case for an electronic device whereby the sleeve or case may stretch or conform to the shape of the device.
